(19) United States
(12) Patent Application Publication
(10) Pub. No.: US 2026/0131680 A1
(43) Pub. Date: May 14, 2026

(54) INVERTER DEVICE INTEGRATED WITH TWO-WAY OBC FUNCTION AND CONTROL METHOD

(71) Applicants: HYUNDAI MOTOR COMPANY, SEOUL (KR); KIA CORPORATION, SEOUL (KR)

(72) Inventors: Tae Yeong Lee, Hwaseong-si (KR); Sung Yong Park, Hwaseong-si (KR); Sung Kyu Kim, Hwaseong-si (KR); Jong Kyong Lim, Hwaseong-si (KR)

(73) Assignees: HYUNDAI MOTOR COMPANY, SEOUL (KR); KIA CORPORATION, SEOUL (KR)

(21) Appl. No.: 19/197,203

(22) Filed: May 2, 2025

(30) Foreign Application Priority Data
Nov. 8, 2024 (KR) 10-2024-0157635

(51) Int. Cl. B60L 53/24; B60L 50/60; B60L 53/10; B60L 55/00; H02M 1/44; H02M 7/797

(52) U.S. Cl. CPC B60L 53/24; B60L 50/60; B60L 53/11; B60L 55/00; H02M 1/44; H02M 7/797; B60L 2210/30; B60L 2210/40

(57) ABSTRACT

An inverter device integrated with a two-way OBC function includes a main leg unit including N legs connected between a DC terminal connected to a battery and an AC terminal connected to a motor, and having a pair of high-side switches and a pair of low-side switches, an auxiliary leg unit connected or separated between a common positive terminal and a common negative terminal of the main leg unit, and including the pair of high-side switches and the pair of low-side switches, and an auxiliary switch connecting the auxiliary leg unit or DC power to the main leg unit according to a motor driving/V2L function mode (AC load connection), a slow charging mode (AC power connection), or a rapid charging mode (DC power connection), and a connection unit for selectively connecting one of AC load, AC power and DC power to a neutral node of the motor.

### CROSS REFERENCE TO RELATED APPLICATIONS

This application claims benefit of priority to Korean Patent Application No. 10-2024-0157635 filed on Nov. 8, 2024, in the Korean Intellectual Property Office, the disclosure of which is incorporated herein by reference in its entirety.

### BACKGROUND

### 1. Field

The present disclosure relates to an inverter device integrated with a two-way OBC function and a control method thereof.

### 2. Description of Related Art

In general, electric vehicles are vehicles driven using energy stored in energy storage devices such as batteries, and from the perspective of driving and energy supply, such electric vehicles may be equipped with a motor system for driving a vehicle motor, a charging system for charging a battery, or a V2L converter for supporting a Vehicle To Load (V2L) function.

Recently, with an increase in demand for multifunctionality in vehicles, research or development related to packaging of Power Electric (PE) systems have been conducted in various manners so as to improve the usability of vehicle space while supporting multifunctionality such as motor driving, charging, and V2L functions, and reducing an occupation area thereof.

### SUMMARY

An aspect of the present disclosure is to provide an inverter device integrated with a two-way OBC function, which may connect both AC load, AC power and DC power, and may support a motor driving/V2L function mode (AC load connection), a slow charging mode (AC power connection) and a rapid charging mode (DC power connection), and a control method thereof.

The aspects to be solved by the present disclosure are not limited to the above-mentioned aspects, and other aspects not mentioned herein will be clearly understood by those skilled in the art from the following description.

According to an aspect of the present disclosure, provided is an inverter device integrated with a two-way OBC function including an integrated inverter including a main leg unit including N legs connected between a DC terminal connected to a battery and an AC terminal connected to each of three-phase inductors of a motor, and having a pair of high-side switches and low-side switches connected to the DC terminal, an auxiliary leg unit connected or separated between a common positive terminal and a common negative terminal of the main leg unit, and including the pair of high-side switches and low-side switches, and an auxiliary switch connecting the auxiliary leg unit or DC power to the main leg unit according to a motor driving/V2L function mode (AC load connection), a slow charging mode (AC power connection), or a rapid charging mode (DC power connection), and a connection unit for selectively connecting one of AC load, AC power and DC power to a neutral node of the motor.

The inverter device integrated with a two-way OBC function is configured to further include an AC filter connected between the output terminal of the connection unit and the auxiliary leg unit and between the connection unit and the auxiliary switch.

The inverter device integrated with a two-way OBC function is configured to further include a controller controlling the auxiliary switch, the main leg unit, the auxiliary leg unit, and the connection unit of the integrated inverter, according to the motor driving/V2L function mode (AC load connection), the slow charging mode (AC power connection), or the rapid charging mode (DC power connection).

The controller is configured to include a first controller configured to generate a main leg control signal for controlling a high-side switch and a low-side switch of the main leg unit and generate an auxiliary leg control signal for controlling a high-side switch and a low-side switch of the auxiliary leg unit, according to the motor driving/V2L function mode (AC load connection), the slow charging mode (AC power connection), or the rapid charging mode (DC power connection), and a second controller configured to generate a first switching control signal for controlling the auxiliary switch of the integrated inverter and generate a second switching control signal for controlling the connection unit, according to the motor driving/V2L function mode (AC load connection), the slow charging mode (AC power connection), or the rapid charging mode (DC power connection).

The first controller is configured to include a first motor driving/V2L function mode controller configured to generate a main leg control signal based on a torque command value, for driving a motor and output the main leg control signal to the main leg unit, in the motor driving/V2L function mode (AC load connection), and a second motor driving/V2L function mode controller configured to generate an auxiliary leg control signal based on a voltage command value for performing a V2L function and output the signal to the auxiliary leg unit, in the motor driving/V2L function mode (AC load connection).

The first motor driving/V2L function mode controller is configured to include: a current command value calculation unit configured to generate a d-axis current command value and a q-axis current command value based on the torque command value and mechanical angular velocity, for driving the motor, in the motor driving/V2L function mode (AC load connection), and a voltage command value calculation unit configured to generate a d-axis voltage command value and a q-axis voltage command value based on the d-axis and q-axis current command values and d-axis and q-axis current measurement values, and a main control signal generation portion configured to generate the main leg control signal based on the d-axis and q-axis voltage command values.

The second motor driving/V2L function mode controller is configured to include a V/I conversion portion configured to convert the voltage command value into a current command value, based on an input measurement voltage, a first duty command value calculation unit configured to generate a duty command value based on an input measurement current and the current command value, and a first PWM modulator configured to generate the auxiliary leg control signal based on the duty command value.

The auxiliary leg unit is connected to the main leg unit under the control of the controller, in the motor driving/V2L function mode (AC load connection), the connection unit is turned on under the control of the controller in the motor driving/V2L function mode (AC load connection), the main leg unit of the integrated inverter operates as a three-phase inverter under the control of the first motor driving/V2L function mode controller, and generates a three-phase driving current to be supplied to the three-phase inductor of the motor based on a DC voltage of the battery, in the motor driving/V2L function mode (AC load connection), and the auxiliary leg unit operates under the control of the second motor driving/V2L function mode controller, and generates an AC load current to be supplied to the AC load connected to the connection unit through an AC filter based on the DC voltage of the battery.

The first controller is configured to further include a slow charging mode controller configured to generate the main leg control signal and the auxiliary leg control signal, based on a battery voltage command value and a battery voltage, in order to perform slow charging of the battery, in the slow charging mode (AC power connection) in which the AC power is connected.

The slow charging mode controller is configured to include a first charging mode determination and current command value calculation unit configured to determine a charging mode and generate a current command value for controlling slow charging of the battery according to the determined charging mode, based on the battery voltage command value, the battery voltage and the input measurement voltage, in the slow charging mode (AC power connection), a second duty command value calculation unit configured to generate a duty command value based on the current command value, the measurement voltage, and the three-phase driving current of the motor, and a second PWM modulator configured to generate the main leg control signal and the auxiliary leg control signal, based on the duty command value.

The auxiliary leg unit is connected to the main leg unit under the control of the controller in the slow charging mode (AC power connection), the connection unit is turned on under the control of the controller, in the slow charging mode (AC power connection), the main leg unit of the integrated inverter operates as a three-phase interleaved totem-pole converter under the control of the slow charging mode controller, in the slow charging mode (AC power connection), and generates a DC voltage for supplying slow charging energy to the battery based on a charging current by the AC power, and the auxiliary leg unit provides a pass of the charging current flowing to the AC load connected to the connection unit in conjunction with the AC filter under the control of the slow charging mode controller.

The first controller is configured to further include a rapid charging mode controller configured to generate the main leg control signal and the auxiliary leg control signal, based on the battery voltage command value and the battery voltage, in order to perform rapid charging of the battery, in the rapid charging mode (DC power connection).

The rapid charging mode controller is configured to further include a second charging mode determination and current command value calculation unit configured to determine the charging mode and generate a current command value for controlling rapid charging of the battery according to the determined charging mode, based on the battery voltage command value and the battery voltage, in the rapid charging mode (DC power connection), a third duty command value calculation unit configured to generate a duty command value based on the current command value, the DC voltage of the DC power, and a DC current between the motor and the integrated inverter; and a third PWM modulator configured to generate the main leg control signal and the auxiliary leg control signal, based on the duty command value.

The auxiliary leg unit is separated from the main leg unit under the control of the controller, in the rapid charging mode (DC power connection), the connection unit is turned on under the control of the controller, in the rapid charging mode (DC power connection), the main leg unit of the integrated inverter operates as a three-phase interleaved boost converter under the control of the rapid charging mode controller, in the rapid charging mode (DC power connection), and generates a DC voltage for supplying rapid charging energy to the battery based on a charging current by DC power, the auxiliary leg unit of the integrated inverter does not operate, and the AC filter is connected to the auxiliary switch and the connection unit under the control of the rapid charging mode controller to provide a path for the charging current flowing to DC load connected to the connection unit.

Furthermore, according to another aspect of the present disclosure, provided is a control method of an inverter device integrated with a two-way OBC function including an operation mode determination operation of determining a motor driving/V2L function mode, a slow charging mode (AC power connection) or a rapid charging mode (DC power connection), and an integrated inverter control operation of controlling a main leg unit, an auxiliary leg unit, a first switch (mode selection switch), and a second switch (load selection switch) of an integrated inverter according to a preset control sequence for the motor driving/V2L function mode, the slow charging mode (AC power connection) or the rapid charging mode (DC power connection) determined in the operation mode determination operation.

The integrated inverter control operation is configured to include a first motor driving/V2L function mode control operation of controlling an auxiliary switch and a connection unit in the motor driving/V2L function mode, and generating a main leg control signal based on a torque command value, mechanical angular velocity and a dq current and outputting the main leg control signal to the main leg unit of the integrated inverter, a second motor driving/V2L function mode control operation of generating an auxiliary leg control signal based on an AC voltage command value, an AC current and an AC voltage and outputting the auxiliary leg control signal to the auxiliary leg unit, in the motor driving/V2L function mode, a slow charging mode control operation of controlling the auxiliary switch and the connection unit in the slow charging mode (AC power connection), and generating a main leg control signal and an auxiliary leg control signal based on the torque command value, the AC voltage, and the AC current, and a rapid charging mode control operation of controlling the auxiliary switch and the connection unit in the rapid charging mode (DC power connection), and generating a main leg control signal and an auxiliary leg control signal based on the torque command value and the AC current.

The first motor driving/V2L function mode control operation is configured to include: a current command value calculation operation of generating a d-axis current command value and a q-axis current command value, based on the torque command value and the mechanical angular velocity, for driving a motor, in the motor driving/V2L function mode (AC load connection), a voltage command value calculation operation of generating a d-axis voltage command value and a q-axis voltage command value based on the d-axis and q-axis current command values, and a control signal generation operation of generating the main leg control signal based on the d-axis and q-axis voltage command values.

The second motor driving/V2L function mode control operation is configured to include a V/I conversion operation of converting the voltage command value into a current command value based on an input measurement voltage, a first duty command value calculation operation of generating a duty command value based on an input measurement current and the current command value, and a first PWM modulation operation of generating the auxiliary leg control signal based on the duty command value.

The slow charging mode control operation is configured to include a first charging mode determination and current command value calculation operation of determining a charging mode based on a battery voltage command value, a battery voltage, and the measurement voltage, in the slow charging mode (AC power connection), and generating a current command value for controlling slow charging of the battery according to the determined charging mode, a second duty command value calculation operation of generating a duty command value based on the current command value, the measurement voltage, and a three-phase driving current of the motor, and a second PWM modulation operation of generating the main leg control signal and the auxiliary leg control signal, based on the duty command value.

The rapid charging mode control operation is configured to includes a second charging mode determination and current command value calculation operation of determining a charging mode based on a battery voltage command value and a battery voltage, in the rapid charging mode (DC power connection), and generating a current command value for controlling rapid charging of the battery according to the determined charging mode, a third duty command value calculation operation of generating a duty command value, based on the current command value, the DC voltage of the DC power, and a DC current between the motor and the integrated inverter, and a third PWM modulation operation of generating the main leg control signal and the auxiliary leg control signal based on the duty command value.

Additionally, aspects of the present disclosure are not limited to the aspects exemplified above, and other aspects may be additionally understood in the course of the description below.

According to an aspect of the present disclosure, when one inverter device integrated with a two-way OBC function is adopted, there are advantages in that AC load, AC power, and DC power may all be connected, and a motor driving/V2L function mode (AC load connection), a slow charging mode (AC power connection), and a rapid charging mode (DC power connection) may be all supported.

Additionally, when one inverter device integrated with a two-way OBC function as described above is applied, the effect of reducing an occupation area, suppressing weight increase, and reducing costs in vehicles to which the inverter device integrated with a two-way OBC function is applied may be expected.

Advantages and effects of the present application are not limited to the foregoing content and other unmentioned effects may be more easily understood in the process of describing a specific example embodiment of the present disclosure from the following descriptions.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 is a conceptual diagram of an inverter device integrated with a two-way OBC function according to an example embodiment of the present disclosure;

FIG. 2 is an example view of an internal configuration of a controller;

FIG. 3 is an example view of a first controller for a motor driving/V2L function mode;

FIG. 4 is an example view of an internal configuration of a main control signal generation unit of FIG. 3;

FIG. 5 is an example view of an internal configuration of a first PWM modulator of FIG. 3;

FIG. 6 is an example view of a main signal waveform of FIGS. 4 and 5;

FIG. 7 is a diagram illustrating an operation of an integrated inverter device in a motor driving/V2L function mode;

FIG. 8 is an example view of a main signal waveform of the integrated inverter device of FIG. 7;

FIG. 9 is an example view of a first controller for a slow charging mode;

FIG. 10 is an example view of an internal configuration of the second PWM modulator of FIG. 9;

FIG. 11 is an example view of the main signal waveform of FIG. 10;

FIG. 12 is a view illustrating an operation of an integrated inverter device in a slow charging mode;

FIG. 13 is an example view of a main signal waveform of the integrated inverter device of FIG. 12;

FIG. 14 is an explanatory view illustrating a case in which 3-phase AC power is connected;

FIG. 15 is an example view of a first controller for a rapid charging mode;

FIG. 16 is an example view of an internal configuration of the third PWM modulator of FIG. 15;

FIG. 17 is an example view of the main signal waveform of FIG. 16;

FIG. 18 is a view illustrating an operation of an integrated inverter device, in a rapid charging mode;

FIG. 19 is an example view illustrating a change in a main signal of the integrated inverter device of FIG. 17;

FIG. 20 is a flowchart illustrating a method of controlling an inverter device integrated with a two-way OBC function according to an example embodiment of the present disclosure;

FIG. 21 is a flowchart illustrating an integrated inverter control operation;

FIG. 22 is a flowchart illustrating a first motor driving/V2L function mode control operation;

FIG. 23 is a flowchart illustrating a second motor driving/V2L function mode control operation;

FIG. 24 is a flowchart illustrating a slow charging mode control operation; and

FIG. 25 is a flowchart illustrating a rapid charging mode control operation.

In the drawings and detailed descriptions, the same reference numerals refer to the same components. The drawings may not be to scale, and the relative sizes, proportions, and depictions of drawing elements may be exaggerated for clarity, explanation, and convenience.

### DETAILED DESCRIPTION

Hereinafter, a specific embodiment of the present disclosure will be described with reference to the drawings. The following detailed description is provided to help gain a comprehensive understanding of methods, apparatuses, and/or systems described herein. However, this is only an example, and the present disclosure is not limited thereto.

In describing example embodiments of the present disclosure in detail, when it is determined that a detailed description of known technologies associated with the present disclosure may unnecessarily obscure the gist of the present disclosure, the detailed description thereof will be omitted. Furthermore, the terms described below are defined in consideration of functions in the present disclosure, and may vary according to the intention or practice of a user or an operator. Therefore, the definition thereof should be based on the content throughout this specification. The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a portion or combinations thereof, and shall not be construed to preclude any presence or possibility of one or more other characteristics, numbers, steps, operations, elements, parts or combinations thereof.

Hereinafter, example embodiments of the present disclosure will be described with reference to the accompanying drawings.

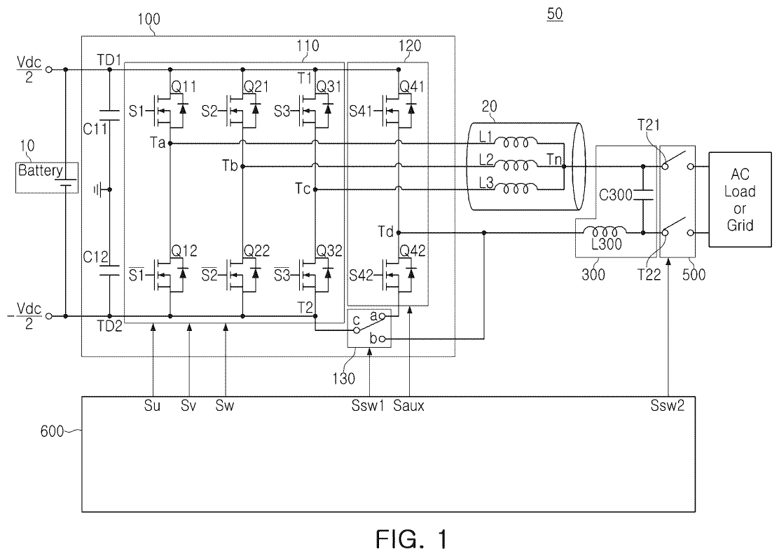

FIG. 1 is a conceptual diagram of an inverter device integrated with a two-way OBC function according to an example embodiment of the present disclosure.

Referring to FIG. 1, an inverter device 50 integrated with a two-way OBC function according to an example embodiment of the present disclosure may include an integrated inverter 100 and a connection unit 500.

The integrated inverter 100 may include a main leg unit 110, an auxiliary leg unit 120, and an auxiliary switch 130.

The main leg unit 110 may include N legs connected between DC terminals TD1 and TD2 connected to a battery 10 and AC terminals Ta, Tb and Tc connected to each of three-phase inductors L1, L2 and L3 of a motor 20, and having a pair of high-side switches Q11, Q21 and Q31 and low-side switches Q12, Q22 and Q32 connected to the DC terminals TD1 and TD2.

For example, a common positive terminal T1 of the main leg unit 110 may be connected to the first DC terminal TD1 connected to a first terminal +Vdc/2 of two first and second terminals +Vdc/2 and −Vdc/2 of the battery 10, and a common negative terminal T2 of the main leg unit 110 may be connected to a second DC terminal TD2 connected to the second terminal −Vdc/2 of the battery 10.

For example, the battery 10 may be connected to the first and second DC terminals TD1 and TD2 of the main leg unit 110 through the first and second terminals +Vdc/2 and −Vdc/2.

In the present disclosure, for example, for convenience of explanation and understanding, three legs, that is, first legs Q11 and Q12, second legs Q21 and Q22, and third legs Q31 and Q32, may be included, but the present disclosure is not limited thereto, and the legs (e.g., the first legs Q11 and Q12) may include a pair of high-side switch Q11 and low-side switch Q12, the second legs Q21 and Q22 may include a pair of high-side switch Q21 and low-side switch Q22, and the third legs Q31 and Q32 may include a pair of high-side switch Q31 and low-side switch Q32.

For example, one terminal of each of the high-side switches Q11, Q21 and Q31 of the first legs Q11 and Q12, the second legs Q21 and Q22, and the third legs Q31 and Q32 may be connected to a first DC terminal TD1 connected to the first terminal +Vdc/2 of the battery 10, and the other terminal of each of the high-side switches Q11, Q21 and Q31 of the first legs Q11 and Q12, the second legs Q21 and Q22, and the third legs Q31 and Q32 may be connected to one terminal of each of the low-side switches Q12, Q22 and Q32 of the first legs Q11 and Q12, the second legs Q21 and Q22, and the third legs Q31 and Q32. Additionally, the other terminal of each of the low-side switches Q12, Q22 and Q32 of the first legs Q11 and Q12, the second legs Q21 and Q22, and the third legs Q31 and Q32 may be connected to the second DC terminal TD2.

The auxiliary leg unit 120 may be connected or separated between the common positive terminal T1 and the negative terminal T2 of the main leg portion, and may include a pair of high-side switch Q41 and low-side switch Q42. For example, the auxiliary leg unit 120 may be connected (e.g., motor driving/V2L function mode or slow charging mode) or separated (e.g., rapid charging mode) between the common positive terminal T1 and the common negative terminal T2 of the main leg portion 110.

For example, one terminal of the high-side switch Q41 of the auxiliary leg unit 120 may be connected to the common positive terminal T1 of the main leg portion 110, and the other terminal of the high-side switch Q41 of the auxiliary leg unit 120 may be connected to one terminal of the low-side switch Q42 of the auxiliary leg unit 120. Additionally, the other terminal of the low-side switch Q42 of the auxiliary leg unit 120 may be connected to one terminal (terminal a) of the auxiliary switch 130.

The auxiliary switch 130 may connect the auxiliary leg unit 120 or DC power to the main leg portion 110 according to the motor driving/V2L function mode (AC load connection), the slow charging mode (AC power connection) or the rapid charging mode (DC power connection). For example, the auxiliary switch 130 may connect the common negative terminal T2 of the main leg portion 110 to the other terminal of the auxiliary leg unit 120 or an output terminal Td, which is an intermediate node of the auxiliary leg unit 120 according to the motor driving/V2L function mode (AC load connection), the slow charging mode (AC power connection) or the rapid charging mode (DC power connection).

For example, the intermediate node of the auxiliary leg unit 120 may be a node in which the high-side switch Q41 and the low-side switch Q42 are connected to each other. As an example, the auxiliary switch 130 may include a first switch formed of a relay having a common terminal (terminal c), one terminal (terminal a) and the other terminal (terminal b).

In the present disclosure, the motor 20 may be a motor having a three-phase Y connection formed of a three-phase inductors L1, L2 and L3 based on a neutral node Tn. Each of the three-phase inductors L1, L2 and L3 may be connected to each of the AC terminals Ta, Tb and Tc of the integrated inverter 100, and the neutral node Tn may be connected to the connection unit 500.

The connection unit 500 may selectively connect one of AC load (V2L function portion), AC power, and DC power to the neutral node Tn of the motor 20.

For example, the connection unit 500 may include a second switch for connecting one of the AC load (V2L function portion), the AC power, and the DC power to the neutral node Tn of the motor 20. For example, when the neutral node Tn of the motor 20 is connected to the AC load (V2L function portion) through the connection unit 500, the integrated inverter device of the present disclosure may operate in the motor driving/V2L function mode. When the neutral node Tn of the motor 20 is connected to the AC power through the connection unit 500, the integrated inverter device of the present disclosure may operate in the slow charging mode. Additionally, when the neutral node Tn of the motor 20 is connected to the DC power through the connection unit 500, the integrated inverter device may operate in the rapid charging mode, and this will be described below with reference to FIGS. 1 to 19.

Additionally, referring to FIG. 1, the inverter device 50 integrated with a two-way OBC function may include an AC filter 300 and a controller 600.

The AC filter 300 may be connected between the connection unit 500 and the output terminal Td of the auxiliary leg unit 120 and between the connection unit 500 and the auxiliary switch 130. For example, the AC filter 300 may be connected between the output terminal Td of the auxiliary leg unit 120 and the connection unit 500 and between the connection unit 500 and the other terminal (terminal b) of the auxiliary switch 130.

For example, the AC filter 300 may include an inductor L300 and a capacitor C300. One terminal of the capacitor C300 may be connected to the neutral node Tn of the motor 20 and one terminal T21 of the connection unit 500, and the other terminal may be connected to the other terminal T22 of the connection unit 500. One terminal of the inductor L300 may be connected to the other terminal of the capacitor C300, and the other terminal of the inductor L300 may be connected to the output terminal Td, which is an intermediate node of the auxiliary leg unit 120, and the other terminal (terminal b) of the auxiliary switch 130.

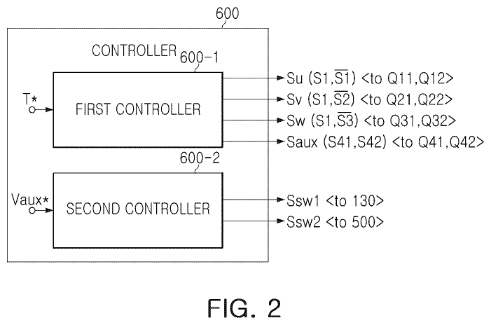

The controller 600 may control the auxiliary switch 130, the main leg unit 110, the auxiliary leg unit 120, and the connection unit 500 of the integrated inverter 100 according to the motor driving/V2L function mode (AC load connection), the slow charging mode (AC power connection), or the rapid charging mode (DC power connection). This will be described below with reference to FIGS. 2 to 19.

For each drawing of the present disclosure, unnecessary redundant descriptions of components with the same symbols and functions may be omitted, and possible differences may be described for each drawing.

FIG. 2 is an example view of an internal configuration of a controller.

Referring to FIGS. 1 and 2, the controller 600 may include a first controller 600-1 and a second controller 600-2.

For example, the first controller 600-1 may generate main leg control signals Su, Sv and Sw for controlling the high-side switches Q11, Q21 and Q31 and the low-side switches Q12, Q22 and Q32 of the main leg unit 110, according to the motor driving/V2L function mode (AC load connection), the slow charging mode (AC power connection) or the rapid charging mode (DC power connection), and may generate an auxiliary leg control signal Saux for controlling the high-side switch Q41 and the low-side switch Q42 of the auxiliary leg unit 120.

For example, the main leg control signals Su, Sv and Sw may include three-phase leg control signals, i.e., a first leg control signal Su, a second leg control signal Sv, and a third leg control signal Sw, for controlling three legs, i.e., the first legs Q11 and Q12, the second legs Q21 and Q22, and the third legs Q31 and Q32.

For example, the first leg control signal Su may include signals S1 and S̅1̅ having a complementary phase to each other, so as to control the high-side switch Q11 and the low-side switch Q12 of the first legs Q11 and Q12. The second leg control signal Sv may include signals S2 and S̅2̅ having a complementary phase to each other, so as to control the high-side switch Q21 and the low-side switch Q22 of the second legs Q21 and Q22. Additionally, the third leg control signal Sw may include signals S3 and S̅3̅ having a complementary phase to each other, so as to control the high-side switch Q31 and the low-side switch Q32 of the third legs Q31 and Q32.

For example, an auxiliary leg control signal Saux may include signals S41 and S42 for controlling the high-side switch Q41 and the low-side switch Q42 of the auxiliary leg unit 120.

For example, the second controller 600-2 may generate a first switching control signal Ssw1 for controlling the auxiliary switch 130 of the integrated inverter 100, according to the motor driving/V2L function mode (AC load connection), the slow charging mode (AC power connection) or the rapid charging mode (DC power connection), and may generate a second switching control signal Ssw2 for controlling the connection unit 500.

For example, the first switching control signal Ssw1 may be a one-terminal (terminal a) on control signal for the auxiliary switch 130 to connect the auxiliary leg unit 120 to the main leg unit 110 in the motor driving/V2L function mode, may be a one-terminal (terminal a) on control signal for the auxiliary switch 130 to connect the auxiliary leg unit 120 to the main leg unit 110 in the slow charging mode, and may be an other-terminal (terminal b) on control signal for the auxiliary switch 130 to separate the main leg unit 110 and the auxiliary leg unit 120 in the rapid charging mode and connect the connection 500 or the AC filter 300 to the common negative terminal T2 of the main leg unit 110.

The second switching control signal Ssw2 may be an ON control signal for AC load connection in the motor driving/V2L function mode, may be an ON control signal for AC power connection in the slow charging mode, and may be an ON control signal for DC power connection in the rapid charging mode. For example, when the inverter device 50 integrated with a two-way OBC function (see FIG. 1) is in a disabled state, the second switching control signal Ssw2 may be an OFF control signal.

In the present disclosure, each of the first controller 600-1 and the second controller 600-2 may be implemented as individual processors, or may be implemented as one processor, and the present disclosure should not be construed as being limited to either one thereof.

Additionally, each of the first controller 600-1 and the second controller 600-2 may be implemented as hardware element(s) or software element(s) or combinations thereof in at least one integrated circuit (IC) built into the inverter device integrated with a two-way OBC function, and the present disclosure should not be construed as being limited to any one thereof.

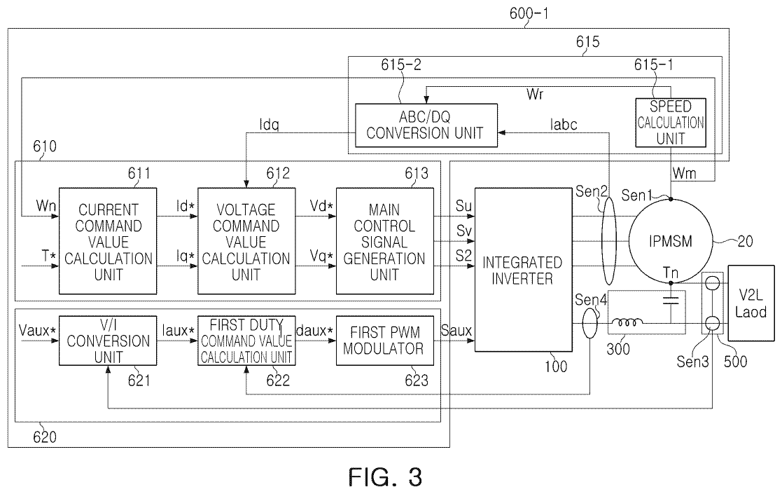

FIG. 3 is an example view of a first controller 600-1 for a motor driving/V2L function mode.

Referring to FIGS. 1 to 3, the first controller 600-1 may include a first motor driving/V2L function mode controller 610 and a second motor driving/V2L function mode controller 620.

The first motor driving/V2L function mode controller 610 may generate main leg control signals Su, Sv and Sw based on a torque command value T* for driving a motor and output the torque command value T* to the main leg unit 110, in the motor driving/V2L function mode (AC load connection).

The second motor driving/V2L function mode controller 620 may generate an auxiliary leg control signal Saux based on a measurement current Iaux inputted as a voltage command value Vaux* for performing the V2L function and output the auxiliary leg control signal Saux to the auxiliary leg unit 120, in the motor driving/V2L function mode (AC load connection).

Hereinafter, the first motor driving/V2L function mode controller 610 and the second motor driving/V2L function mode controller 620 will be described in more detail.

For example, the first motor driving/V2L function mode controller 610 may include a current command value calculation unit 611, a voltage command value calculation unit 612, and a main control signal generation unit 613.

The current command value calculation unit 611 may generate a d-axis current command value Id* and a q-axis current command Iq* based on the torque command value T* and the mechanical angular velocity Wm for driving a motor, in the motor driving/V2L function mode (AC load connection).

The voltage command value calculation unit 612 may generate a d-axis voltage command value Vd* and a q-axis voltage command value Vq* based on the d-axis and q-axis current command values Id* and Iq* and the d-axis and q-axis current measurement values Id and Iq.

Additionally, the main control signal generation unit 613 may generate the main leg control signals Su, Sv and Sw based on the d-axis and q-axis voltage command values Vd* and Vq*.

For example, the second motor driving/V2L function mode controller 620 may include a V/I conversion unit 621, a first duty command value calculation unit 622, and a first PWM modulator 623.

The V/I conversion unit 621 may convert the voltage command value Vaux* into a current command value Iaux* based on an input measurement voltage Vaux. For example, the measurement voltage Vaux may be measured by a third sensor Sen3 disposed in the connection unit 500, and may be a voltage supplied to the connection unit 500 by the auxiliary leg unit 120.

The first duty command value calculation unit 622 may generate a duty command value duax* based on the input measurement current Iaux and the input current command value Iaux*. For example, the measurement current Iaux may be measured by a fourth sensor Sen4 disposed in the AC filter 300 and may be a current supplied by the auxiliary leg unit 120.

The first PWM modulator 623 may generate the auxiliary leg control signal Saux based on the duty command value duax*.

Meanwhile, the first motor driving/V2L function mode controller 610 may further include a circuit unit 615 including a speed calculation unit 615-1 and an abc/dq conversion unit 615-2.

The speed calculation unit 615-1 may calculate electrical angular velocity Wr based on the mechanical angular velocity Wm measured by a first sensor Sen1 for the motor 20, and the abc/dq conversion unit 615-2 may convert three-phase driving currents Iabc (Ia, Ib and Ic) measured by a second sensor Sen2 into two-phase dq-axis current measurement values Idq (Id, Iq) using electrical angular velocity Wr.

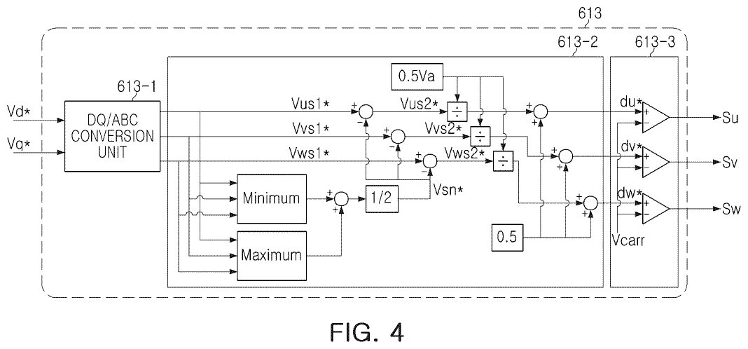

FIG. 4 is an example view of an internal configuration of the main control signal generation unit 613 of FIG. 3.

Referring to FIG. 4, the main control signal generation unit 613 may include a dq/abc conversion unit 613-1, a duty operation unit 613-2, and a signal generation unit 613-3.

The dq/abc conversion unit 613-1 may convert the two-phase d-axis and q-axis voltage command values Vd* and Vq* into the 3-phase first voltage command values Vus*, Vvs* and Vws*.

The duty operation unit 613-2 may generate the three-phase duty command values du*, dv* and dw* through operations (e.g., subtraction, multiplication and addition) on the first voltage command values Vus*, Vvs* and Vws*.

For example, the calculation unit 613-2 may generate an average voltage command value Vsn* by adding and averaging a minimum value and a maximum value based on the first voltage command values Vus1*, Vvs1* and Vws1*, and may generate second voltage command values Vun2*, Vvn2* and Vwn2* by subtracting the first voltage command values Vus1*, Vvs1* and Vws1*, and may generate the three-phase duty command values du*, dv* and dw*^{*} by dividing a set voltage value (e.g., 0.5 Vdc) by the second voltage command values Vun2*, Vvn2* and Vwn2* and adding a set value (e.g., 0.5).

Additionally, the signal comparison unit 613-3 may generate the main leg control signals Su, Sv and Sw by comparing the three-phase duty command values du*, dv* and dw* with a reference voltage Vcarr.

The internal configuration of the main control signal generation unit 613 illustrated in FIG. 4 is only an example for the convenience of understanding and explanation, and therefore, the present disclosure is not limited thereto.

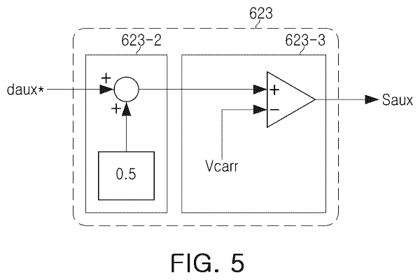

FIG. 5 is an example view of an internal configuration of the first PWM modulator 623 of FIG. 3.

Referring to FIG. 5, the first PWM modulator 623 may include a calculation unit 623-1 and a comparison unit 623-2.

The calculation unit 623-1 may generate an added duty command value duax1* by adding a set constant (e.g., 0.5) to the duty command value duax*.

The comparison unit 623-2 may generate an auxiliary leg control signal Saux by comparing an added duty command value duax1*^{*} and the reference voltage Vcarr.

The internal configuration of the first PWM modulator 623 illustrated in FIG. 5 is only an example for the convenience of understanding and explanation, and the present disclosure is not limited thereto.

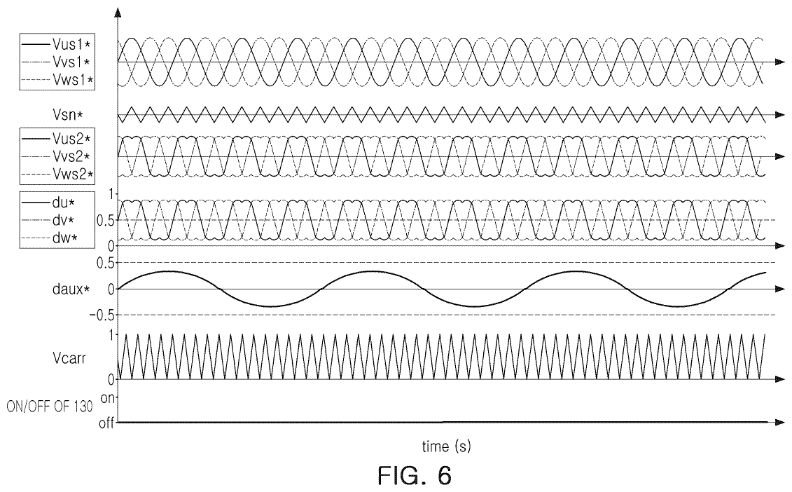

FIG. 6 is an example view of the main signal waveforms of FIGS. 4 and 5.

FIG. 6 illustrates, in order of the illustrating, an AC signal waveform example view having a phase difference of 120 degrees for three-phase voltage reference values Vus*, Vvs* and Vws*, a signal waveform example view of a triangle shape for the average voltage reference value Vsn*, an AC signal waveform example view having a phase difference of 120 degrees for the second voltage reference values Vun, Vvn* and Vwn*, an AC signal waveform example view having a position difference of 120 degrees for the three phase duty reference values du*, dv* and dw*, an AC signal waveform example view for the duty reference value duax*, a voltage signal waveform example view of a triangle shape having a minimum of 0 V and a maximum of 1 V for the reference voltage Vcarr, and a graph illustrating on and off operations of the auxiliary switch 130.

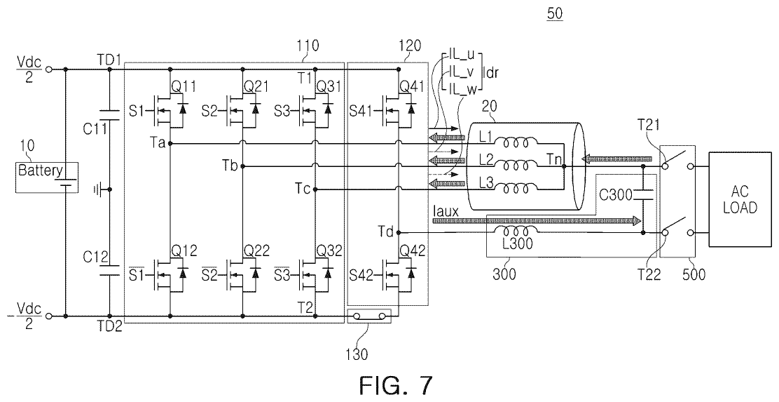

FIG. 7 is a diagram illustrating an operation of the integrated inverter device in the motor driving/V2L function mode.

Referring to FIG. 7, when explaining the operation of the integrated inverter device 50 in the motor driving/V2L function mode, first, the auxiliary leg unit 120 may be connected to the main leg unit 110 under the control of the controller 600, in the motor driving/V2L function mode (AC load connection).

For example, under the control of the first switching control signal Ssw1 of the second controller 620, the common terminal (terminal c) of the auxiliary switch 130 may be connected to one terminal (terminal a). Accordingly, the auxiliary leg unit 120 may be connected to the main leg unit 110 through the auxiliary switch 130.

Additionally, the connection unit 500 may be turned on under the control of the controller 600 in the motor driving/V2L function mode (AC load connection), so that the AC load may be connected to the neutral node Tn of the AC filter 300 and the motor 20.

For example, the connection unit 500 may be turned on according to the second switching control signal Ssw2 of the second controller 620, so that the AC load may be connected to the neutral node Tn of the motor 20 and the AC filter 300.

Next, when describing an operation of the integrated inverter 100, the main leg portion 110 may operate as a three-phase inverter under the control of the first motor driving/V2L function mode control section 610, in the motor driving/V2L function mode (AC load connection), and may generate three-phase driving currents Idr (IL_u, IL_v and IL_w) to be supplied to the three-phase inductors L1, L2 and L3 of the motor 20 based on the DC voltage of the battery 10 of the first and second DC terminals TD1 and TD2 and may output the same to the motor 20 through the AC terminals Ta, Tb and Tc. The three-phase driving current Idr may be supplied to the motor 20 so that the motor 20 may be driven.

For example, in order for the integrated inverter 100 to operate as a three-phase inverter according to the main leg control signals Su, Sv and Sw of the first controller 600-1, the high-side switches Q11, Q21 and Q31 and the low-side switches Q12, Q22 and Q32 included in the main leg unit 110 may operate according to the signals S1 and S̅1̅, the signals S2 and S̅2̅, and the signals S3 and S̅3̅ having complementary phases of the main leg control signals Su, Sv and Sw, so that the DC voltage of the battery 10 of the first and second DC terminals TD1 and TD2 may be converted into the three-phase driving currents IL_u, IL_v and IL_w and output through the AC terminals Ta, Tb and Tc.

In detail, for example, the high-side switch Q11 and the low-side switch Q12 of the main leg unit 110 may be complementarily turned on/off, the high-side switch Q21 and the low-side switch Q22 may also be complementarily turned on/off, and the high-side switch Q31 and the low-side switch Q32 may also be complementarily turned on/off. That is, the high-side switches Q11, Q21 and Q31 may be sequentially turned on in order of a phase difference of 120 degrees, and accordingly, the low-side switches Q12, Q22 and Q32 may be sequentially turned off in order of a phase difference of 120 degrees. Through this operation, DC/AC conversion may be performed in the main leg portion 110, and eventually, three-phase driving currents IL_u, IL_v and IL_w may be generated.

In the present disclosure, since the operation of the main leg portion 110 of the integrated inverter 100 is the same as the operation of a typical three-phase inverter, a more detailed description thereof is omitted.

Additionally, the auxiliary leg unit 120 may operate under the control of the second motor driving/V2L function mode control section 620, and may generate an AC load current Iaux (e.g., V2L function current) to be supplied to the AC load connected to the connection section 500 through the AC filter 300 based on the DC voltage of the battery 10. The AC load current Iaux (e.g., V2L function current) may be supplied to the AC load through the connection section 500.

For example, the high-side switch Q41 and the low-side switch Q42 included in the auxiliary leg unit 120 may operate, according to the signals S41 and S42 having complementary phases of the auxiliary leg control signal Saux, so that the auxiliary leg unit 120 of the integrated inverter 100 may generate an AC load current Iaux according to the auxiliary leg control signal Saux of the first controller 600-1, and thus, the DC voltage of the battery 10 may be converted into an AC load current Iaux (e.g., V2L function current).

In detail, for example, the high-side switch Q41 and the low-side switch Q42 of the auxiliary leg unit 120 may be complementarily turned on/off to generate AC load current Iaux. For example, when the high-side switch Q41 is in an on state, the low-side switch Q42 is in an off state, and conversely, when the high-side switch Q41 is in the off state, the low-side switch Q42 may be in the on state, and through this operation, DC/AC conversion may be performed in the auxiliary leg unit 120, and eventually AC load current Iaux may be generated.

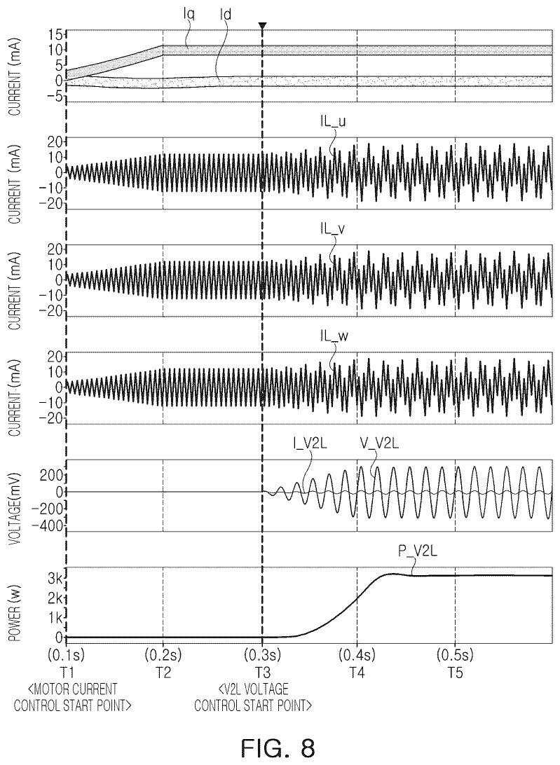

FIG. 8 is an example view of the main signal waveform of the integrated inverter device of FIG. 7.

FIG. 8 illustrates, for example, an example main signal waveform view illustrating simulation results of the integrated inverter device according to the motor driving/V2L function mode.

Referring to FIG. 8, a simulation sequence of FIG. 8 starts motor current control for torque control from time T1 (e.g., 0.1 s), and may perform voltage control for the V2L function from time T2.

First, a waveform of the dq-axis currents Iq and Iq illustrates a dq-axis current for torque control of a permanent magnet motor (e.g., SPMSM). Assuming a Permanent Magnet Synchronous Motor (SPMSM), results of performing control by inputting a current command value of 10 A for the q-axis and 0 A for the d-axis from T1 (e.g., 0.1 s) to T2 (e.g., 0.2 s) is illustrated.

Next, a waveform the motor driving currents Idr (IL_u, IL_v and IL_w) illustrates the three-phase motor current of the U, V, and W phases of the motor 20 through the inductors L1, L2 and L3 of the motor 20. It may be confirmed that the motor currents IL_u, IL_v and IL_w are controlled to 10 Apk for a torque output before the time T2 (e.g., 0.2 s). For example, it may be confirmed that an offset value of the three-phase current fluctuates as the voltage control is performed for the V2L operation from T3 (e.g., 0.3 s).

Next, waveforms of V2L load voltage V_V2L and V2L load current I_V2L illustrate the voltage and current of the V2L load. It may be seen that the V2L load is simulated as a resistive load, and the V2L voltage and current has the same phase. It may be confirmed that an effective value of the V2L voltage from time T3 (e.g., 0.3 s) to time T4 (e.g., 0.4 s) is controlled from 0 V to 220 V. It may be confirmed that the inverter constantly supplies about 3 kW of power consumed by the V2L load after time T4 (e.g., 0.4 s).

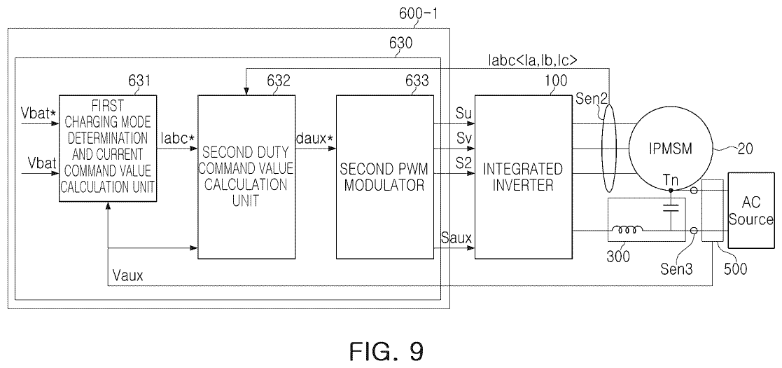

FIG. 9 is an example view of the first controller 600-1 for the slow charging mode.

Referring to FIG. 9, the first controller 600-1 may include a slow charging mode controller 630.

For example, the slow charging mode controller 630 may generate main leg control signals Su, Sv and Sw and an auxiliary leg control signal Saux, based on a battery voltage command value Vbat* and measurement voltage Vaux input from the battery voltage Vbat, for the purpose of slow charging of the battery 10, in the slow charging mode (AC power connection) in which the AC power is connected.

For example, the slow charging mode controller 630 may include a first charging mode determination and current command value calculation unit 631, a second duty command value calculation unit 632, and a second PWM modulator 633.

The first charging mode determination and current command value calculation unit 631 may determine a charging mode based on the battery voltage command value Vbat*, the battery voltage Vbat, and the input measurement voltage Vaux, in the slow charging mode (AC power connection), and may generate the current command value Iaux* for controlling slow charging of the battery 10 according to the determined charging mode. For example, the measurement voltage Vaux may be measured by the third sensor Sen3 disposed in the connection unit 500.

The second duty command value calculation unit 632 may generate the duty command value duax*, based on the current command value Iaux*, the measurement voltage Vaux and a three-phase driving current Iabc of the motor 20. For example, the three-phase driving current Iabc may be measured by a second sensor Sen2 disposed in the output terminal of the integrated inverter 100.

Additionally, the second PWM modulator 633 may generate main leg control signals Su, Sv and Sw and an auxiliary leg control signal Saux based on the duty command value duax*.

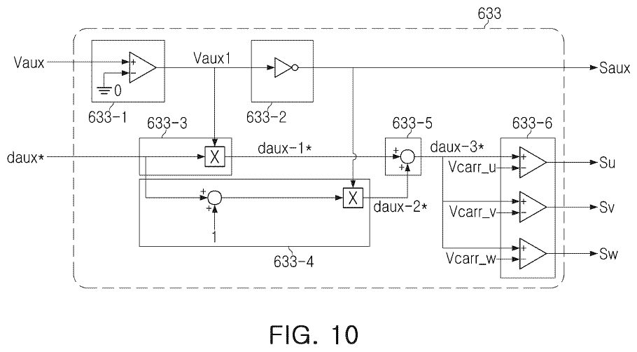

FIG. 10 is an example view of an internal configuration of the second PWM modulator 633 of FIG. 9.

Referring to FIG. 10, the second PWM modulator 633 may include an input comparison unit 633-1, an inverting unit 633-2, a first operation unit 633-3, a second operation unit 633-4, a third operation unit 633-5, and an output comparison unit 633-6.

For example, the input comparison unit 633-1 may compare the input auxiliary voltage Vaux with zero voltage and may output a first auxiliary voltage Vaux1 having a level higher than the zero voltage.

The inversion unit 633-2 may invert the first auxiliary voltage Vaux1 output from the input comparison unit 633-1 to generate an auxiliary leg control signal Saux.

The first calculation unit 633-3 may multiply the duty command value duax* by the first auxiliary voltage Vaux1 output from the input comparison unit 633-1 and may output a first duty command value duax-1*.

The second operation unit 633-4 may add a set value (e.g., 1) to the duty command value duax* and may multiply the auxiliary leg control signal Saux output from the inverting unit 633-2 to output a second duty command value duax-2*.

The third operation unit 633-5 may add the second duty command value duax-2* output from the second operation unit 633-4 to the first duty command value duax-1* output from the first operation unit 633-3 to generate a third duty command value daux3*.

Additionally, the output comparison unit 633-6 may generate the main leg control signals Su, Sv and Sw by comparing the third duty command value daux3* and three-phase reference voltages Vcarr_u, Vcarr_v and Vcarr_w.

An internal configuration of the second PWM modulator 633 illustrated in FIG. 10 is only an example for the convenience of understanding and explanation, and is not limited thereto.

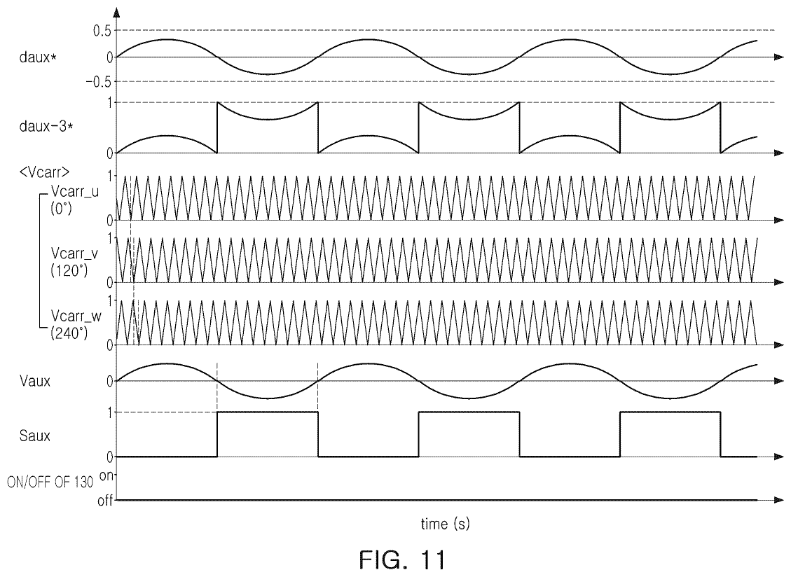

FIG. 11 is an example view of the main signal waveform of FIG. 10.

FIG. 11 illustrates, in order of the illustrating, an AC signal waveform example view for a duty command value daux*, an waveform example view for a third duty command value daux3*, a triangular voltage signal waveform having a minimum of 0 V and a maximum of 1 V for three-phase reference voltages Vcarr_u, Vcarr_v and Vcarr_w, an AC signal waveform example view for an auxiliary voltage Vaux, a pulse-shaped signal waveform example view for an auxiliary leg control signal Saux, and a graph illustrating on and off operations of the auxiliary switch 130.

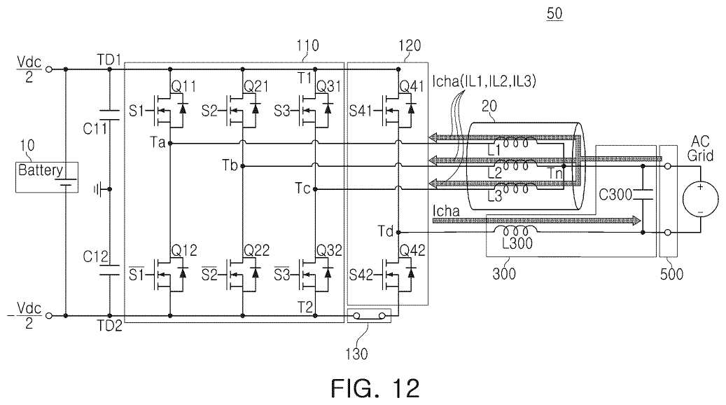

FIG. 12 is a view illustrating an operation of an integrated inverter device in a slow charging mode.

Referring to FIG. 12, when describing the operation of the integrated inverter device 50 in the slow charging mode, first, the auxiliary leg unit 120 may be connected to the main leg unit 110 under the control of the controller 600 in the slow charging mode (AC power connection). This is the same as the operation in the motor driving/V2L function mode explained with reference to FIG. 7 and thus, further descriptions are omitted.

The connection unit 500 may be turned on under the control of the controller 600 in the slow charging mode (AC power connection), and may connected AC power to the neutral node Tn of the motor 20.

Additionally, when describing an operation of the integrated inverter 100, the main leg unit 110 may operate as a three-phase interleaved totem_pole converter under the control of the slow charging mode controller 630 in the slow charging mode (AC power connection).

In detail, the main leg portion 110 of the integrated inverter 100 may receive charging currents Icha (IL1, IL2 and IL3) from the AC power via the three-phase inductors L1, L2 and L3 of the motor 20 through the AC terminals Ta, Tb and Tc, and the three-phase inductors L1, L2 and L3 of the motor 20 and the high-side switch Q11, Q21 and Q31 and the low-side switch Q12, Q22 and Q32 included in the main leg portion 110 of the integrated inverter 100 may operate as a single-phase boost converter, thus generating a DC voltage Vdc for supplying slow charging energy to the first and second DC terminals TD1 and TD2 of the battery 10 based on a charging current Icha from the AC power.

For example, in order for the integrated inverter 100 to operate as a single-phase boost converter according to the main leg control signals Su, Sv and Sw of the first controller 600-1, the high-side switches Q11, Q21 and Q31 and the low-side switches Q12, Q22 and Q32 included in the main leg unit 110 may operate according to the signals S1 and S̅1̅, the signals S2 and S̅2̅ and the signals S3 and S̅3̅ of the main leg control signals Su, Sv and Sw having complementary phases to each other, so that the charging current Icha of the AC power input through the AC terminals Ta, Tb and Tc may be converted into a DC voltage Vdc and may be supplied to the battery 10 through the first and second DC terminals TD1 and TD2, thereby charging the battery 10.

In detail, for example, the high-side switches Q11, Q21 and Q31 of the main leg unit 110 may be sequentially turned on in order of a phase difference of 120 degrees, and accordingly, the low-side switches Q12, Q22 and Q32 may perform an on/off switching operation. Through this operation, AC/DC conversion may be performed in the main leg unit 110, and ultimately, a DC voltage V/dc for charging may be generated from the AC power.

Additionally, the auxiliary leg unit 120 of the integrated inverter 100 may provide a pass of the charging current Icha flowing to the AC load connected to the connection unit 500 in conjunction with the AC filter 300 under the control of the slow charging mode controller 630.

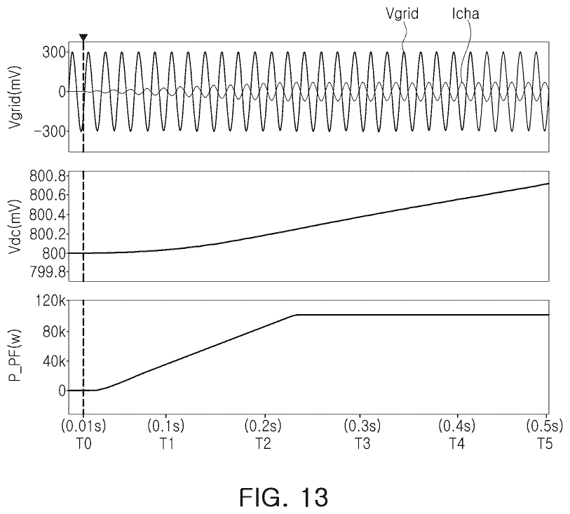

FIG. 13 is an example view of a main signal waveform of the integrated inverter device of FIG. 12.

FIG. 13 illustrates an example of waveforms for main signals according to simulation results, for example, when the slow charging mode operates.

Referring to FIG. 13, a simulation sequence of FIG. 13 starts PFC current control for slow charging from time T0 (e.g., 0.01 s).

First, waveforms of grid voltage Vgrid and current Icha show the grid voltage Vgrid of the AC power of charging equipment (e.g., EVSE: Electric Vehicle Supply Equipment) and the AC current Icha, which is the sum of the currents flowing through the three phases of the motor during charging. For example, the grid voltage Vgrid is an effective value of 220V, and the AC current Icha starts with an effective value of 0 A and increases for 0.2 s to be controlled to about 50 A in order to control the power at about 11 kW. Furthermore, the AC current Icha phase may be seen to be in a reverse direction with respect to a grid voltage phase during a charging operation when the flow from the inverter to the grid is seen to be in a forward direction.

Next, a waveform of the DC voltage Vdc shows that the battery voltage is charged through the slow charging operation and gradually increases from an initial voltage of 800 V.

Next, a waveform of charging power P_PFC is a result of measuring the magnitude of the charging power during the slow charging operation. It may be confirmed that the charging power also increases from 0 W to 11 kW as the magnitude of the charging current increases from the time T0 (e.g., 0.01 s) to the time T2 (e.g., 0.2 s).

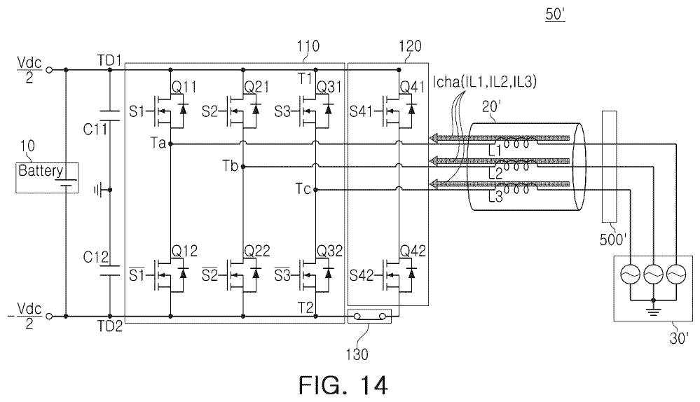

FIG. 14 is an explanatory view for a case in which a three-phase AC power is connected.

Referring to FIG. 14, in the inverter device 50 integrated with a two-way OBC function (see FIG. 1) of the present disclosure, a single-phase AC power may be connected to the connection unit 500 (see FIG. 1) in FIG. 12, and, unlike this, as illustrated in FIG. 14, a three-phase AC power may be connected to a connection unit 500′.

In this case, the main leg portion 110 of the integrated inverter 100 may operate as a power factor compensation (PFC) converter in the same manner as the main leg portion 110 of FIG. 12.

However, the auxiliary leg unit 120 may be in a mode off state.

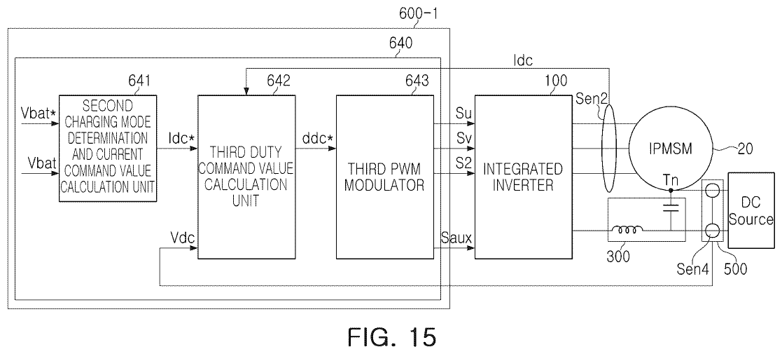

FIG. 15 is an example view of a first controller 600-1 for a rapid charging mode.

Referring to FIG. 15, the first controller 600-1 may include a rapid charging mode controller 640.

The rapid charging mode controller 640 may, for example, generate the main leg control signals Su, Sv and Sw and the auxiliary leg control signal Saux, based on the battery voltage command value Vbat*, for purpose of rapid charging of the battery 10 in the rapid charging mode (DC power connection).

Referring to FIG. 15, an example of an internal configuration of the rapid charging mode controller 640 will be described.

Referring to FIG. 15, the rapid charging mode controller 640 may include a second charging mode determination and current command value calculation unit 641, a third duty command value calculation unit 642, and a third PWM modulator 643.

The second charging mode determination and current command value calculation unit 641 may determine a charging mode based on the battery voltage command value Vbat* and the battery voltage Vbat, in the rapid charging mode (DC power connection), and may generate a current command value Idc* for controlling rapid charging of the battery 10 according to the determined charging mode. For example, in the charging mode, a constant current (CC) charging mode may be initially determined, and a constant voltage (CV) charging mode may be changed when the charging voltage exceeds a certain reference.

The third duty command value calculation unit 642 may generate a duty command value ddc* based on the current command value Idc*, the DC voltage Vdc of the DC power, and a DC current Idc between the motor 20 and the integrated inverter 100. For example, the DC current Idc may be measured by the second sensor Sen2 disposed in a current interconnection line between the motor 20 and the integrated inverter 100. The DC voltage Vdc may be measured by a fourth sensor Sen4 disposed in the connection unit 500.

The third PWM modulator 643 may generate the main leg control signals Su, Sv and Sw and the auxiliary leg control signal Saux based on the duty command value ddc*.

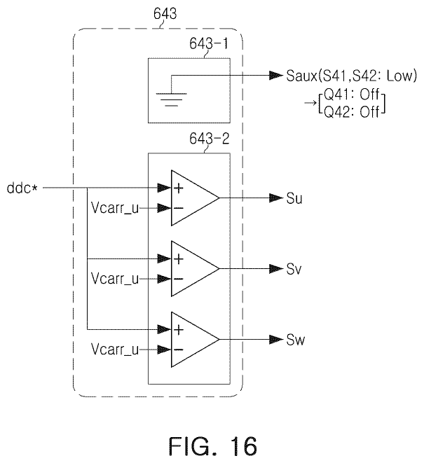

FIG. 16 is an example view of an internal configuration of the third PWM modulator 643 of FIG. 15.

Referring to FIG. 16, the third PWM modulator 643 may include an auxiliary leg control signal setting unit 643-1 and an output comparison unit 6443-1.

For example, the auxiliary leg control signal setting unit 643-1 may output an off signal (low level signal) for signals S41 and S42 included in the auxiliary leg control signal Saux.

The output comparison unit 6443-1 may compare the duty command value ddc* and three-phase reference voltages Vcarr_u, Vcarr_v and Vcarr_w to generate main leg control signals Su, Sv and Sw.

The internal configuration of the third PWM modulator 643 illustrated in FIG. 16 is only an example for the convenience of understanding and explanation, and therefore, the present disclosure is not limited thereto. In the present disclosure, each of the high level and the off level may be logic 1 or logic 0, and the high level and the low level may be voltage levels, and the present disclosure is limited thereto. In the disclosure, even if an active high system is described as an example, this is only an example for the convenience of explanation and understanding, and therefore, the present disclosure is not limited thereto and may also be applied to an active low system.

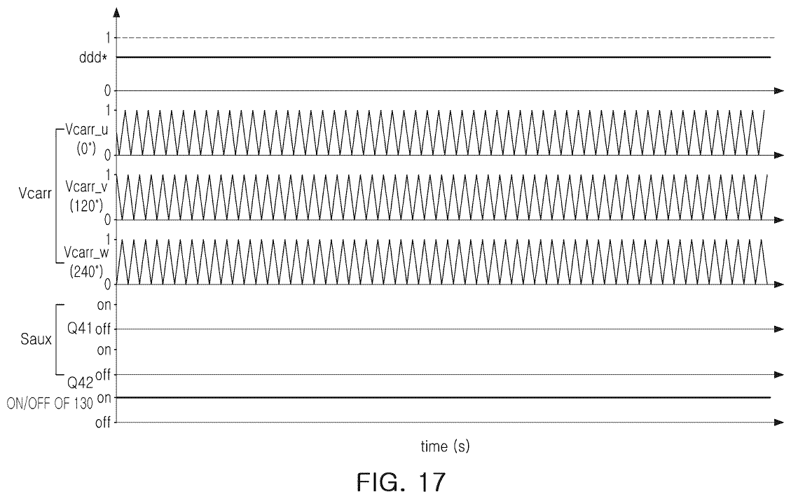

FIG. 17 is an example view of the main signal waveform of FIG. 16.

FIG. 17 illustrates, in order of the illustrating, a graph for a command value signal having a constant value between 0 and 1 for the duty DC command ddc*, a triangular voltage signal waveform view having a minimum of 0 V and a maximum of 1 V for the three-phase reference voltages Vcarr Vcarr_u, Vcarr_v and Vcarr_w, a view illustrating an operation state of the high-side switch Q41 and the low-side switch Q42 according to the auxiliary leg control signal Saux, and a graph illustrating on and off operations of the auxiliary switch 130.

Referring to FIG. 17, the high-side switch Q41 and the low-side switch Q42 of the auxiliary leg unit 120 are in an off state.

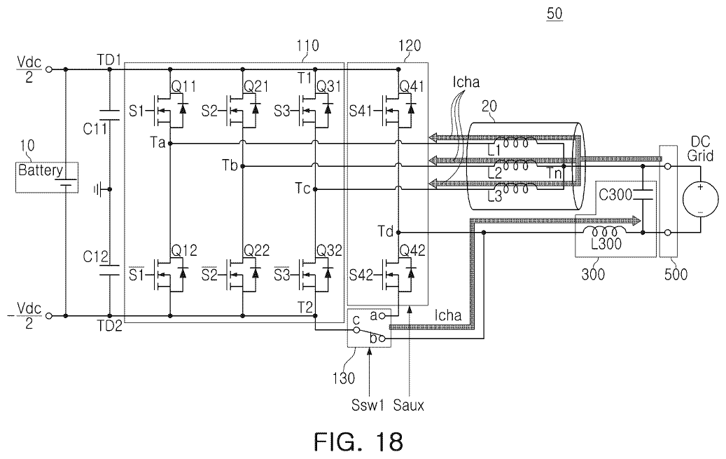

FIG. 18 is a view illustrating an operation of an integrated inverter device in rapid charging mode.

Referring to FIG. 18, when describing an operation of the integrated inverter device 50 in the rapid charging mode, first, the auxiliary leg unit 120 may be separated from the main leg unit 110 under the control of the controller 600, in the rapid charging mode (DC power connection), and in this case, the two switches Q41 and Q42 of the auxiliary leg unit 120 may be in a mode off state.

The connection unit 500 may be turned on under the control of the controller 600 in the rapid charging mode (DC power connection), and accordingly, the DC power may be connected to the AC filter 300 and the neutral node Tn of the motor 20 by the connection unit 500.

Next, the main leg portion 110 of the integrated inverter 100 may operate as a three-phase interleaved boost converter under the control of the rapid charging mode controller 640, in the rapid charging mode (DC power connection).

In detail, the main leg portion 110 may generate a DC voltage Vdc for supplying rapid charging energy to the battery 10 based on the charging current Icha by the DC power. In this case, the auxiliary leg unit 120 of the integrated inverter 100 does not operate.

Additionally, the AC filter 300 may be connected to the auxiliary switch 130 and the connection unit 500 under the control of the rapid charging mode controller 640 to supply a pass for the charging current Icha flowing to the DC load connected to the connection unit 500.

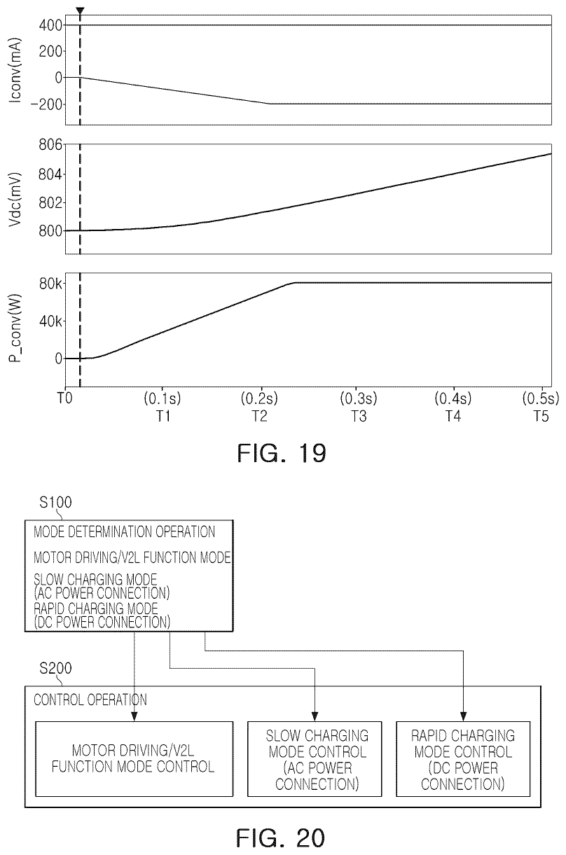

FIG. 19 is an example view illustrating a change in a main signal of the integrated inverter device of FIG. 17.

FIG. 19 illustrates an example of changes in main signals according to simulation results, for example, when the rapid charging mode operates.

Referring to FIG. 19, a simulation sequence of FIG. 19 starts DC current control for rapid charging from time TO (e.g., 0.01 s).

First, a graph of DC power voltage V_EVSE is a graph illustrating an example of a voltage change of the DC power of charging equipment EVSE, and a graph of DC charging current I_conv is a graph illustrating an example of changes in the current, which is the sum of the currents flowing in the three-phase inductors L1, L2 and L3 of the motor 20 during charging. For example, it may be confirmed that the DC power voltage V_EVSE is approximately 400V, and the magnitude of the DC charging current I_conv starts at 0[A] to control at approximately 70 kW power, and increases for T2 (e.g., 0.2 s) to be controlled at approximately 200 A.

Next, a graph of DC charging voltage Vdc is a graph in which the battery voltage is charged through the rapid charging operation and increases from the initial voltage of 800V. For example, it may be confirmed that since the DC voltage Vdc has a higher charging power than that of the slow charging mode, voltage increase speed thereof is faster during charging.

Next, a graph of charging power P_conv is a graph illustrating a change in charging power, which measures the magnitude of the charging power during rapid charging. For example, it may be confirmed that the charging operation starts from the time T0 (e.g., 0.01 s) and the charging power also increases from 0 W to 70 kW as the magnitude of the charging current increases during approximately the time T2 (e.g., 0.2 s).

Hereafter, with reference to FIGS. 20 to 25, a control method of controlling an integrated inverter device with two-way OBC function will be described. In the present disclosure, the description of the control method of controlling an integrated inverter device with two-way OBC function and the description of the inverter device integrated with a two-way OBC function may be applied complementarily or commonly, unless they are mutually exclusive. Accordingly, overlapping descriptions may be omitted. Hereinafter, a main process of the control method of controlling an integrated inverter device with two-way OBC function will be described.

FIG. 20 is a flowchart illustrating an inverter device integrated with a two-way OBC function control method according to an example embodiment of the present disclosure.

Referring to FIG. 2 and FIG. 20, a control method of an inverter device integrated with a two-way OBC function according to an example embodiment of the present disclosure may be performed by the inverter device 50 integrated with a two-way OBC function.

Referring to FIG. 1 and FIG. 20, the control method of the inverter device integrated with a two-way OBC function may include an operation mode determination operation (S100) and an integrated inverter control operation (S200).

First, in the operation mode determination operation (S100), the inverter device 50 integrated with a two-way OBC function may determine the motor driving/V2L function mode, the slow charging mode (AC power connection) or the rapid charging mode (DC power connection).

Next, in the integrated inverter control operation (S200), the inverter device 50 integrated with a two-way OBC function may control the main leg portion 110, the auxiliary leg unit 120, the first switch (mode selection switch) 130, and the second switch (load selection switch) of the integrated inverter 100, according to a preset control sequence for the motor driving/V2L function mode, the slow charging mode (AC power connection) or the rapid charging mode (DC power connection) determined in the operation mode determination operation (S100).

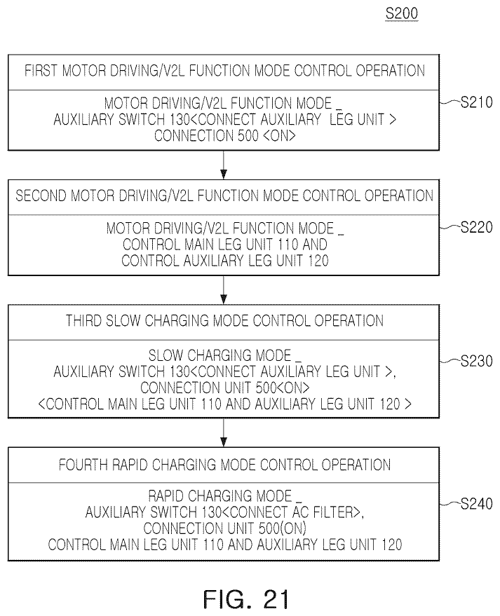

FIG. 21 is a flow chart illustrating an integrated inverter control operation (S200).

Referring to FIG. 1 and FIG. 21, the integrated inverter control operation (S200) may include a first motor driving/V2L function mode control operation (S210), a second motor driving/V2L function mode control operation (S220), a slow charging mode control operation (S230), and a rapid charging mode control operation (S240).

In the first motor driving/V2L function mode control operation (S210), the inverter device 50 integrated with a two-way OBC function may control the auxiliary switch 130 and the connection unit 500, in the motor driving/V2L function mode, and may generate main leg control signals Su, Sv and Sw based on the torque command value T*, the mechanical angular velocity Wm, and the dq current Idq, and may output the same to the main leg portion 110 of the integrated inverter 100.

In the second motor driving/V2L function mode control operation (S220), the inverter device 50 integrated with a two-way OBC function may generate an auxiliary leg control signal Saux based on an AC voltage command value Vac*, an AC current Iac, and AC voltage Vac, in the motor driving/V2L function mode, and may output the same to the auxiliary leg unit 120.

In the slow charging mode control operation (S230), the inverter device 50 integrated with a two-way OBC function may control the auxiliary switch 130 and the connection unit 500, in the slow charging mode (AC power connection), and may generate main leg control signals Su, Sv and Sw and an auxiliary leg control signal Saux based on the Vba torque command value T*, the AC voltage Vac and the AC current Iac.

Additionally, in the rapid charging mode control operation (S240), the inverter device 50 integrated with a two-way OBC function may control the auxiliary switch 130 and the connection unit 500, in the rapid charging mode (DC power connection), and may generate the main leg control signals Su, Sv and Sw and the auxiliary leg control signal Saux based on the torque command value T* and the AC current Iac.

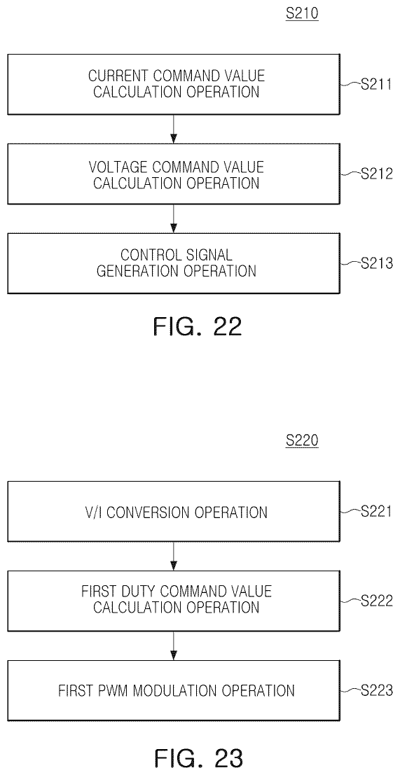

FIG. 22 is a flow chart illustrating the first motor driving/V2L function mode control operation (S210).

Referring to FIG. 1 and FIG. 22, the first motor driving/V2L function mode control operation (S210) may include a current command value calculation operation (S211), a voltage command value calculation operation (S212), and a control signal generation operation (S213).

For example, in the current command value calculation operation (S211), the inverter device 50 integrated with a two-way OBC function may generate the d-axis current command value Id* and the q-axis current command Iq*, in the motor driving/V2L function mode (AC load connection), for driving a motor, based on the torque command value T* and the mechanical angular velocity Wm.

In the voltage command value calculation operation (S212), the inverter device 50 integrated with a two-way OBC function may generate the d-axis voltage command value Vd* and the q-axis voltage command value Vq* based on the d-axis and q-axis current command values Id* and Iq*.

Additionally, in the control signal generation operation (S213), the inverter device 50 integrated with a two-way OBC function may generate the main leg control signals Su, Sv and Sw based on the d-axis and q-axis voltage command values vd* and vq*.

FIG. 23 is a flow chart illustrating the second motor driving/V2L function mode control operation (S220).

Referring to FIG. 1 and FIG. 23, the second motor driving/V2L function mode control operation (S220) may include a V/I conversion operation (S221), a first duty command value calculation operation (S222), and a first PWM modulation operation (S213).

For example, in the V/I conversion operation (S221), the inverter device 50 integrated with a two-way OBC function may convert the voltage command value Vaux* into the current command value Iaux* based on the input measurement voltage Vaux.

In the first duty command value calculation operation (S222), the inverter device 50 integrated with a two-way OBC function may generate the duty command value duax* based on the input measurement current Iaux and the current command value Iaux*.

Additionally, in the first PWM modulation operation (S213), the inverter device 50 integrated with a two-way OBC function may generate the auxiliary leg control signal Saux based on the duty command value duax*.

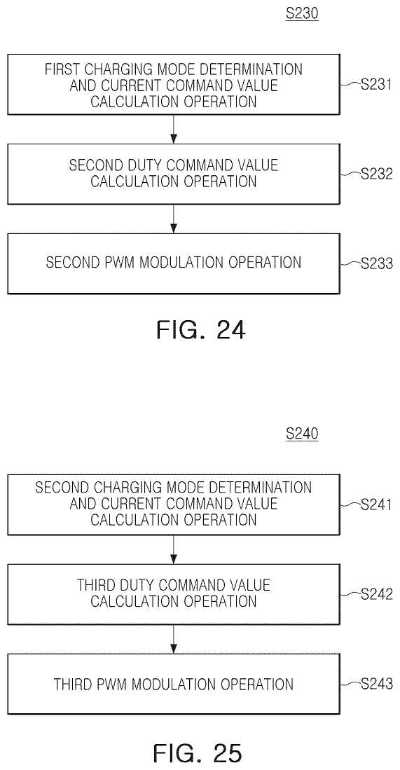

FIG. 24 is a flow chart illustrating the slow charging mode control operation (S230).

Referring to FIG. 1 and FIG. 24, the slow charging mode control operation (S230) may include a first charging mode determination and current command value calculation operation (S231), a second duty command value calculation operation (S232), and a second PWM modulation operation (S233).

For example, in the first charging mode determination and current command value calculation operation (S231), the inverter device 50 integrated with a two-way OBC function may determine a charging mode based on the battery voltage command value Vbat*, the battery voltage Vbat, and the measurement voltage Vaux, in the slow charging mode (AC power connection), and may generate a current command value Iaux* for controlling slow charging of the battery 10 according to the determined charging mode.

In the second duty command value calculation operation (S232), the inverter device 50 integrated with a two-way OBC function may generate the duty command value duax* based on the current command value Iaux*, the measurement voltage Vaux, and the three-phase driving current Iabc of the motor 20.

Additionally, in the second PWM modulation operation (S233), the inverter device 50 integrated with a two-way OBC function may generate the main leg control signals Su, Sv and Sw and the auxiliary leg control signal Saux based on the duty command value duax*.

FIG. 25 is a flow chart illustrating the rapid charging mode control operation (S240).

Referring to FIG. 1 and FIG. 25, the rapid charging mode control operation (S240) may include a second charging mode determination and current command value calculation operation (S241), a third duty command value calculation operation (S242), and a third PWM modulation operation (S243).

For example, in the second charging mode determination and current command value calculation operation (S241), the inverter device 50 integrated with a two-way OBC function may determine a charging mode based on the battery voltage command value Vbat* and the battery voltage Vbat in the rapid charging mode (DC power connection), and may generate a current command value Idc* for controlling rapid charging of the battery 10 according to the determined charging mode.

In the third duty command value calculation operation (S242), the inverter device 50 integrated with a two-way OBC function may generate a duty command value ddc* based on the current command value Idc*, the DC voltage Vdc of the DC power, and the DC current Idc between the motor 20 and the integrated inverter 100.

Additionally, in the third PWM modulation operation (S243), the inverter device 50 integrated with a two-way OBC function may generate the main leg control signals Su, Sv and Sw and the auxiliary leg control signal Saux based on the duty command value duax*.

Although representative example embodiments of the present disclosure have been described in detail above, those skilled in the art will understand that the above-described embodiments can be modified in various ways without departing from the scope of the present disclosure. Therefore, the scope of the present disclosure should not be limited to the described example embodiment and should be determined by the claims described below as well as those equivalent to the claims.

1. An inverter device integrated with a two-way OBC function, comprising:
an integrated inverter including:
a main leg unit including N legs connected between a DC terminal connected to a battery, and an AC terminal connected to each of three-phase inductors of a motor, the main leg unit having a pair of high-side switches and a pair of low-side switches each connected to the DC terminal;
an auxiliary leg unit connected or separated between a common positive terminal and a common negative terminal of the main leg unit, the auxiliary leg unit including the pair of high-side switches and the pair of low-side switches; and
an auxiliary switch connecting the auxiliary leg unit or DC power to the main leg unit according to a motor driving/V2L function mode, a slow charging mode, or a rapid charging mode; and
a connection unit configured to connect one of an AC load, AC power, and DC power to a neutral node of the motor.

2. The inverter device integrated with a two-way OBC function according to claim 1, further comprising:
an AC filter connected between an output terminal of the connection unit and the auxiliary leg unit, and between the connection unit and the auxiliary switch.

3. The inverter device integrated with a two-way OBC function according to claim 2, further comprising:
a controller configured to control the auxiliary switch, the main leg unit, the auxiliary leg unit, and the connection unit of the integrated inverter, according to the motor driving/V2L function mode, the slow charging mode, or the rapid charging mode.

4. The inverter device integrated with a two-way OBC function according to claim 3, wherein the controller includes:
a first controller configured to generate a main leg control signal configured to control one of the high-side switches and one of the low-side switches of the main leg unit, and to generate an auxiliary leg control signal for controlling one of the high-side switches and one of the low-side switches of the auxiliary leg unit, according to the motor driving/V2L function mode, the slow charging mode, or the rapid charging mode; and
a second controller configured to generate a first switching control signal for controlling the auxiliary switch of the integrated inverter, and to generate a second switching control signal for controlling the connection unit, according to the motor driving/V2L function mode, the slow charging mode, or the rapid charging mode.

5. The inverter device integrated with a two-way OBC function according to claim 4, wherein the first controller includes:
a first motor driving/V2L function mode controller configured to generate a main leg control signal based on a torque command value for driving a motor, and to output the main leg control signal to the main leg unit, in the motor driving/V2L function mode; and
a second motor driving/V2L function mode controller configured to generate an auxiliary leg control signal based on a voltage command value for performing a V2L function, and to output the auxiliary leg control signal to the auxiliary leg unit, in the motor driving/V2L function mode.

6. The inverter device integrated with a two-way OBC function according to claim 5, wherein the first motor driving/V2L function mode controller includes:
a current command value calculation unit configured to generate a d-axis current command value and a q-axis current command value based on the torque command value and mechanical angular velocity, for driving the motor, in the motor driving/V2L function mode;
a voltage command value calculation unit configured to generate a d-axis voltage command value and a q-axis voltage command value based on the d-axis and q-axis current command values and d-axis and q-axis current measurement values; and
a main control signal generation portion configured to generate the main leg control signal based on the d-axis and q-axis voltage command values.

7. The inverter device integrated with a two-way OBC function according to claim 5, wherein the second motor driving/V2L function mode controller includes:
a V/I conversion portion configured to convert the voltage command value into a current command value, based on an input measurement voltage;
a first duty command value calculation unit configured to generate a duty command value based on an input measurement current and the current command value; and
a first PWM modulator configured to generate the auxiliary leg control signal based on the duty command value.

8. The inverter device integrated with a two-way OBC function according to claim 7, wherein:
the auxiliary leg unit is connected to the main leg unit under the control of the controller, in the motor driving/V2L function mode;
the connection unit is turned on under the control of the controller in the motor driving/V2L function mode;
the main leg unit of the integrated inverter is configured to operate as a three-phase inverter under the control of the first motor driving/V2L function mode controller, and to generate a three-phase driving current to be supplied to the three-phase inductor of the motor based on a DC voltage of the battery, in the motor driving/V2L function mode; and
the auxiliary leg unit is configured to operate under the control of the second motor driving/V2L function mode controller, and to generate an AC load current to be supplied to the AC load connected to the connection unit through an AC filter based on the DC voltage of the battery.

9. The inverter device integrated with a two-way OBC function according to claim 4, wherein the first controller further includes:
a slow charging mode controller configured to generate the main leg control signal and the auxiliary leg control signal, based on a battery voltage command value and a battery voltage, in order to perform slow charging of the battery, in the slow charging mode in which the AC power is connected.

10. The inverter device integrated with a two-way OBC function according to claim 9, wherein the slow charging mode controller includes:
a first charging mode determination and current command value calculation unit configured to determine a charging mode and generate a current command value for controlling slow charging of the battery according to the determined charging mode, based on the battery voltage command value, the battery voltage and an input measurement voltage, in the slow charging mode;
a second duty command value calculation unit configured to generate a duty command value based on the current command value, the measurement voltage, and the three-phase driving current of the motor; and
a second PWM modulator configured to generate the main leg control signal and the auxiliary leg control signal, based on the duty command value.

11. The inverter device integrated with a two-way OBC function according to claim 10, wherein:
the auxiliary leg unit is connected to the main leg unit under the control of the controller in the slow charging mode;
the connection unit is turned on under the control of the controller, in the slow charging mode;
the main leg unit of the integrated inverter is configured to operate as a three-phase interleaved totem-pole converter under the control of the slow charging mode controller, in the slow charging mode, and to generate a DC voltage for supplying slow charging energy to the battery based on a charging current by the AC power; and
the auxiliary leg unit is configured to provide a pass of the charging current flowing to the AC load connected to the connection unit in conjunction with the AC filter under the control of the slow charging mode controller.

12. The inverter device integrated with a two-way OBC function according to claim 4, wherein the first controller further includes:
a rapid charging mode controller configured to generate the main leg control signal and the auxiliary leg control signal, based on a battery voltage command value and a battery voltage, in order to perform rapid charging of the battery, in the rapid charging mode.

13. The inverter device integrated with a two-way OBC function according to claim 12, wherein the rapid charging mode controller further includes:
a second charging mode determination and a current command value calculation unit configured to determine the charging mode and to generate a current command value for controlling rapid charging of the battery according to the determined charging mode, based on the battery voltage command value and the battery voltage, in the rapid charging mode;
a third duty command value calculation unit configured to generate a duty command value based on the current command value, a DC voltage of the DC power, and a DC current between the motor and the integrated inverter; and
a third PWM modulator configured to generate the main leg control signal and the auxiliary leg control signal, based on the duty command value.

14. The inverter device integrated with a two-way OBC function according to claim 13, wherein:
the auxiliary leg unit is separated from the main leg unit under the control of the controller, in the rapid charging mode;
the connection unit is turned on under the control of the controller, in the rapid charging mode;
the main leg unit of the integrated inverter is configured to operate as a three-phase interleaved boost converter under the control of the rapid charging mode controller, in the rapid charging mode, and to generate a DC voltage for supplying rapid charging energy to the battery based on a charging current by DC power;
the auxiliary leg unit of the integrated inverter does not operate; and
the AC filter is connected to the auxiliary switch and the connection unit under the control of the rapid charging mode controller to provide a path for the charging current flowing to DC load connected to the connection unit.

15. A control method of an inverter device integrated with a two-way OBC function, comprising:
determining, by a controller, a motor driving/V2L function mode, a slow charging mode or a rapid charging mode; and
controlling a main leg unit, an auxiliary leg unit, a first switch, and a second switch of an integrated inverter, according to a preset control sequence for the motor driving/V2L function mode, the slow charging mode or the rapid charging mode determined in the operation mode determination operation.

16. The control method of an inverter device integrated with a two-way OBC function according to claim 15, wherein the controlling further includes:
a first motor driving/V2L function mode control operation of controlling an auxiliary switch and a connection unit in the motor driving/V2L function mode, and generating a main leg control signal based on a torque command value, mechanical angular velocity, and a dq current, and outputting the main leg control signal to the main leg unit of the integrated inverter;
a second motor driving/V2L function mode control operation of generating an auxiliary leg control signal based on an AC voltage command value, an AC current and an AC voltage, and outputting the auxiliary leg control signal to the auxiliary leg unit, in the motor driving/V2L function mode;
a slow charging mode control operation of controlling the auxiliary switch and the connection unit in the slow charging mode, and generating a main leg control signal and an auxiliary leg control signal based on the torque command value, the AC voltage, and the AC current; and
a rapid charging mode control operation of controlling the auxiliary switch and the connection unit in the rapid charging mode (DC power connection), and generating a main leg control signal and an auxiliary leg control signal based on the torque command value and the AC current.

17. The control method of an inverter device integrated with a two-way OBC function according to claim 16, wherein the first motor driving/V2L function mode control operation further includes:
a current command value calculation operation of generating a d-axis current command value and a q-axis current command value, based on the torque command value and the mechanical angular velocity, for driving a motor, in the motor driving/V2L function mode;
a voltage command value calculation operation of generating a d-axis voltage command value and a q-axis voltage command value based on the d-axis and q-axis current command values; and
a control signal generation operation of generating the main leg control signal based on the d-axis and q-axis voltage command values.

18. The control method of an inverter device integrated with a two-way OBC function according to claim 16, wherein the second motor driving/V2L function mode control operation further includes:
a V/I conversion operation of converting the voltage command value into a current command value based on an input measurement voltage;
a first duty command value calculation operation of generating a duty command value based on an input measurement current and the current command value; and
a first PWM modulation operation of generating the auxiliary leg control signal based on the duty command value.

19. The control method of an inverter device integrated with a two-way OBC function according to claim 16, wherein the slow charging mode control operation further includes:
a first charging mode determination and current command value calculation operation of determining a charging mode based on a battery voltage command value, a battery voltage, and a measurement voltage, in the slow charging mode, and generating a current command value for controlling slow charging of the battery according to the determined charging mode;
a second duty command value calculation operation of generating a duty command value based on the current command value, the measurement voltage, and a three-phase driving current of the motor; and
a second PWM modulation operation of generating the main leg control signal and the auxiliary leg control signal, based on the duty command value.

20. The control method of an inverter device integrated with a two-way OBC function according to claim 16, wherein the rapid charging mode control operation further includes:
a second charging mode determination and current command value calculation operation of determining a charging mode based on a battery voltage command value and a battery voltage, in the rapid charging mode, and generating a current command value for controlling rapid charging of the battery according to the determined charging mode;
a third duty command value calculation operation of generating a duty command value, based on the current command value, the DC voltage of the DC power, and a DC current between the motor and the integrated inverter; and
a third PWM modulation operation of generating the main leg control signal and the auxiliary leg control signal based on the duty command value.
